(19) United States
(12) Patent Application Publication
(10) Pub. No.: US 2019/0081317 A1
(43) Pub. Date: Mar. 14, 2019

(54) WEB COATING AND CALENDERING SYSTEM AND METHOD

(71) Applicants: Andreas Keil, Munich (DE); Cory Thompson, De Pere, WI (US); Jeffrey Hedtke, Greenville, WI (US); Andrew L Haasl, Green Bay, WI (US); Eric Maki, De Pere, WI (US)

(72) Inventors: Andreas Keil, Munich (DE); Cory Thompson, De Pere, WI (US); Jeffrey Hedtke, Greenville, WI (US); Andrew L Haasl, Green Bay, WI (US); Eric Maki, De Pere, WI (US)

(21) Appl. No.: 15/700,946

(22) Filed: Sep. 11, 2017

(51) Int. Cl. H01M 4/134; H01M 4/04; H01M 4/38

(52) U.S. Cl. CPC H01M 4/134; H01M 4/0404; H01M 4/0435; H01M 4/0471; H01M 4/382

(57) ABSTRACT

Dual sided coating system and method for coating substrates, such as substrates useful as battery electrodes. In certain embodiments, the system includes an inline calender station positioned between the dryer and the rewind of the substrate; i.e., positioned downstream, in the direction of substrate (or web) travel, of the dryer, and upstream of the rewind. In certain embodiments, the calender operation is positioned immediately downstream of the dryer; no intermediate equipment that processes the substrata, such as a vacuum dryer, is positioned between the dryer and the calender. Advantages of such a system and method include twice the throughput compared to single side coating operations, a smaller equipment footprint compared to tandem coating lines, lower capital cost and operating cost compared to tandem coating lines, and fewer issues with wrinkles in the substrate.

### BACKGROUND

The embodiments disclosed herein relate to a system and method for coating a substrate, such as coating operations, for example those used in manufacturing batteries, where the substrate is coated in a series of discrete patches (intermittent coating) and/or in lanes.

There are various applications in which it is desirable to deposit a coating onto at least a portion of a sheet of material. For example, the electrodes of batteries may be produced by applying a layer or coating to a substrate such as a sheet or web, and then cutting the substrate into portions of a suitable dimension. Of particular importance is that the layer be applied at a uniform thickness. For certain applications, the layer or coating is not applied to the sheet in the region where the sheet will subsequently be cut.

Accordingly, systems are used that can apply a uniform layer or coating to a sheet, with the ability to enable and disable the application of that layer as required. For example, in the manufacture of lithium ion batteries and the like, a coating process may be employed that applies anode slurry to a conductive substrate (e.g., copper foil) and another coating process that applies cathode slurry to a conductive substrate (e.g., aluminum foil), such as with a slot die coater. In these two coating processes, there are two different methods of coating: discontinuous, also referred to as skip or patch coating, and continuous coating. In the practice of either method, the coating material may be applied to the continuously moving substrate in the form of one or more lanes running parallel to the travel direction of said continuously moving substrate.

In conventional lithium ion battery electrode manufacture, the current collector substrate (e.g., copper foil) may be coated with slurry of active material (e.g., a lithium based material such as lithium oxide) on one side at a time. The most common coating line layout is the standard single side line. This layout typically has an unwind, coating station, dryer, and rewind. FIG. 1 illustrates a simplified schematic drawing of this single side layout. As can be seen in FIG. 1, the current collector substrate 200 is unwound from a roll 300, and it proceeds to coating station where a first side of the substrate is coated using a coating head 400 (such as one that is part of a slot die coater) while being supported on a backing roll 500. The substrate 200 proceeds into a dryer 600 where the coating is dried, and then the single side coated substrate is wound on a rewind roll 700. The single side coated roll of current collector substrate 200 is then coated on the second, opposite side following the same process (not shown). This process is very inefficient and labor intensive, because the coated rolls of current collector substrate are moved multiple times. Each time a roll of material is unwound and rewound, process scrap is produced, increasing cost.

An alternative to this process involves a tandem coater wherein the coating machine typically has an unwind 300, first coating station 400, first dryer 600, second coating station 400′, second dryer 600′, and rewind 700. FIG. 2 shows this type of layout schematically. As can be seen in FIG. 2, the system used and process carried out for applying the coating to the first side of the substrate 200 is the same as the single side coating system and process of FIG. 1. However, instead of rewinding the single side coated substrate 200, it is directed to a second coating station, followed by a second drying station, after which it is wound on a rewind roll 700. Although a tandem coater solves the problem of multiple unwinding and rewinding steps, the factory footprint for the coating line is doubled in size. In addition, even in a tandem coater system, the current collector substrate is subjected to two separate drying steps; one for drying the coating on the first side, and a second for drying the coating on the second side. The coating on the first side is, therefore, dried twice.

A further problem of the prior art is that because each side is coated and dried sequentially, the coating has a tendency to curl during drying due to the coating shrinking and creating internal stress in the dried coating. This stress causes the substrate 200 to curl up as shown in FIG. 3. Once this dried, curled coating is passed through the next coating station, the curl prevents the coated foil from lying flat against the backing roll. One of the critical parameters for backing roll slot die coating is that the gap between the slot die and substrate must be uniform and parallel. The slot coating process also requires uniform pressure drop across the width of the coating head in order to form a uniform coating thickness. Any difference in pressure drop, which can be caused by a non-uniform coating gap, causes non-uniformity in the wet coating layer. This is shown in FIG. 4, which illustrates that the curl induced from the first-pass coating prevents the foil from lying flat on the backing roll 500. This non-parallel gap between the slot die and substrate causes the wet coating layer to be non-uniform. This non-uniformity is a direct result of the non-uniform coating gap and resulting pressure differential in the coating fluid exiting the slot die. Ideal battery performance generally requires that the coating be uniform on the metal foil substrates. Non-uniform coating results in a difference in the lithium-ion concentration which can create hot spots in the battery that may lead to decreased battery life and/or performance.

Another well-known problem of the existing prior art is that the two side coated electrode must go through an intermediate “dry-down” period in which the previously coated and dried rolls of foil are held for a certain time interval, typically from several hours to several days in a climate controlled environment, such as a low-humidity atmosphere controlled storage chamber/room, or a vacuum chamber where a vacuum drying step is carried out, prior to calendering. This is time consuming, but is required to bring the residual solvent levels in both sides of the electrode coating to the same concentrations. Calendering the electrode without this additional vacuum drying step results in the top and bottom sides of the electrode having different densities and porosities, which is not acceptable.

A still further issue is that because one side of the electrode is dried twice, the composition of the electrode is different from one side to the other in terms of residual solvent, density, porosity, and even binder distribution. The resulting battery electrode produced in this process must then go through a further vacuum drying step (or dry-down period) to further reduce the residual solvent levels within the electrode.

It is therefore an object of embodiments disclosed herein to provide a system and method for dual sided coating of a substrate that does not suffer from the foregoing drawbacks.

### SUMMARY

Problems of the prior art have been overcome by embodiments disclosed herein, which relate to a dual sided coating system and method for coating substrates, such as substrates useful as battery electrodes. In certain embodiments, the system includes an inline calender station positioned between the dryer and the rewind of the substrate; i.e., positioned downstream, in the direction of substrate (or web) travel, of the dryer, and upstream of the rewind. In the embodiments disclosed herein the term “inline” refers to carrying out a first process operation on a continuous web of substrate without winding and subsequent unwinding of said web prior to entering a second process operation. The second operation is then defined as being carried out inline with respect to said first operation. Further, in a series of process operations carried out without intermediate winding and unwinding of the web being processed between said series of process operations is thus described as being carried out inline. Accordingly, the term inline differentiates from an off-line process step, the latter being carried out with at least one intermediate winding step (or other web accumulation storage means) and subsequent unwinding step (or other de-accumulation storage means) prior to said off-line step. In certain embodiments, the calender operation is positioned immediately downstream of the dryer; no intermediate equipment that processes the substrate, such as a vacuum dryer or a controlled atmosphere chamber/room in which the substrate is held for a dry-down period, is positioned between the dryer and the calender. Advantages of such a system and method include twice the throughput compared to single side coating operations, a smaller equipment footprint compared to tandem coating lines, lower capital cost and operating cost compared to tandem coating lines, and fewer issues with wrinkles in the substrate.

In certain embodiments, the system and method eliminates the need for a dry-down period or vacuum drying prior to calendering, by controlling the moisture content of the substrate exiting the dryer.

Accordingly, in some embodiments, a system is provided for coating a substrate such as a web. The system may include a coating station where coating of both sides of the substrate in a single pass is carried out, and a drying station where the coated substrate is dried. In some embodiments, the coating of both sides of the substrate is carried out simultaneously. Since both sides of the substrate are dried once, the coating composition on both sides of the substrate has the same or substantially the same characteristics, including residual solvent level, density, porosity and binder composition. In certain embodiments, the drying is carried out such that a predetermined residual solvent content remains when the substrate exits the dryer. This enables the subsequent calendering process to be carried out without first carrying out a secondary drying process such as vacuum drying.

In certain embodiments, the system is for coating first and second sides of a substrate in a single pass, and includes a first coater for applying a first coating layer to the first side of the substrate; a second coater for applying a second coating layer to the second side of the substrate; a dryer downstream of the second coater for drying the first and second coating layers such that the first and second coating layers retain a predetermined level of a residual solvent when the substrate exits the dryer; and a calender positioned downstream of the dryer for calendering the first and second coating layers. In certain embodiments, the substrate is a metal foil, is planar, and the first side is opposite the second side.

In its method aspects, embodiments disclosed herein relate to a method of coating two sides of a substrate in a single pass, including coating a first side of the substrate, coating a second, opposite side of the substrate, subsequently drying the coatings on the substrate in a dryer to a predetermined residual solvent level, and calendering the substrate without carrying out a secondary drying process prior to calendering. In certain embodiments a secondary drying step is carried out following said calendering process. In a preferred embodiment the secondary drying step is carried out inline following calendering. In certain embodiments, the first and second sides of the substrate are coated simultaneously. The alignment of the coatings on the two sides is improved with simultaneous two-sided coating. In certain embodiments, no vacuum drying or dry-down period of the substrate prior to the calendering operation is carried out. In some embodiments, the drying is carried out in a non-contact manner, e.g., with a flotation dryer where the substrate is floated in the dryer housing without contact with dryer components.

These and other non-limiting aspects and/or objects of the disclosure are more particularly described below. For a better understanding of the embodiments disclosed herein, reference is made to the accompanying drawings and description forming a part of this disclosure.

### BRIEF DESCRIPTION OF THE DRAWINGS

The embodiments disclosed herein may take form in various components and arrangements of components, and in various process operations and arrangements of process operations. The drawings are only for purposes of illustrating preferred embodiments and are not to be construed as limiting.

FIG. 1 is a schematic diagram of a single pass coating layout in accordance with the prior art;

FIG. 2 is a schematic diagram of a tandem coating layout in accordance with the prior art;

FIG. 3 is a diagram of a curled substrate in accordance with the prior art;

FIG. 4 is a schematic diagram of a coated substrate in accordance with the prior art;

FIG. 5 is a schematic diagram of a system for dual side coating of a substrate in accordance with certain embodiments;

FIG. 6 is a schematic diagram of a system for dual side coating of a substrate in accordance with an alternative embodiment;

FIG. 6A is a schematic diagram of a system for dual side coating of a substrate, including a controller, in accordance with an alternative embodiment;

FIG. 7 is a schematic diagram of a system for dual side coating of a substrate in accordance with an alternative embodiment;

FIG. 8 is a schematic diagram of a system for dual side coating of a substrate in accordance with an alternative embodiment;

FIG. 9 is a diagram showing a substrate being slit with a slitter in accordance with certain embodiments;

FIG. 10 is a schematic diagram of a system for dual side coating of a substrate including wet lamination in accordance with certain embodiments;

FIG. 11 is a diagram of an edge coating set up in in accordance with certain embodiments;

FIG. 12 is a schematic diagram of an inline secondary drying operation in accordance with certain embodiments; and

FIG. 13 is a schematic diagram of another embodiment of an inline secondary drying operation.

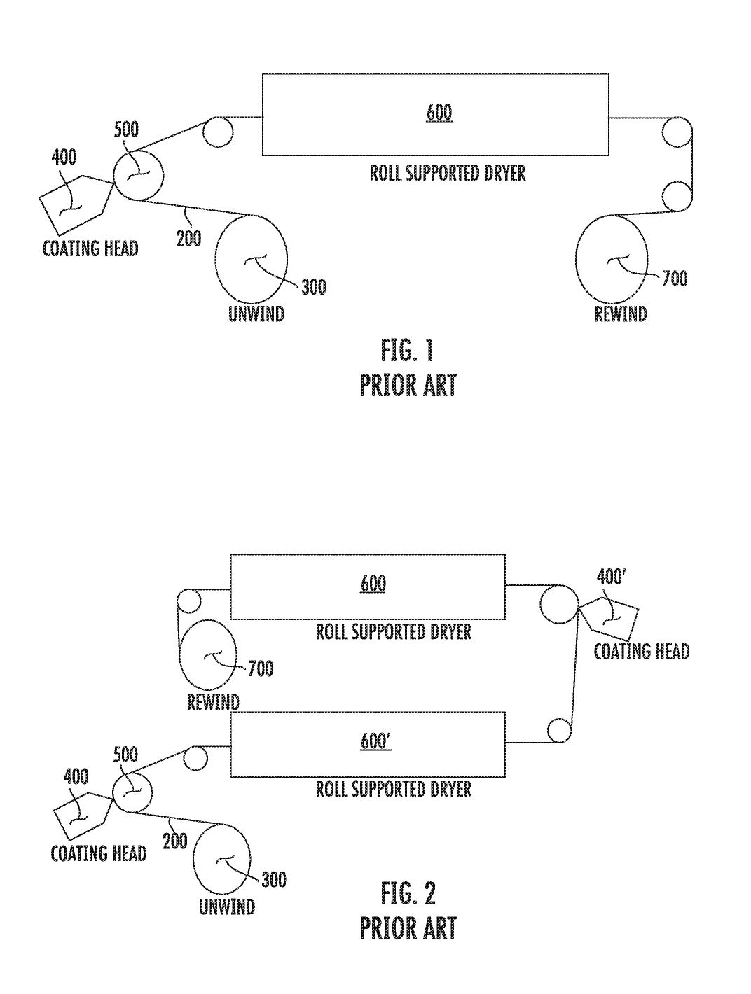

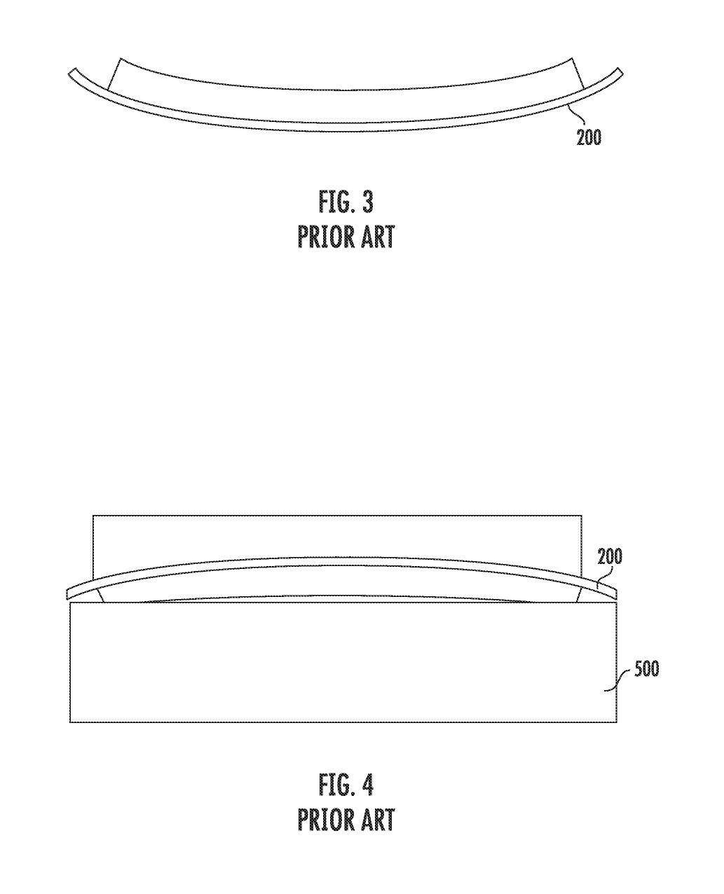

### DETAILED DESCRIPTION

A more complete understanding of the components, processes, systems and apparatuses disclosed herein can be obtained by reference to the accompanying drawings. The figures are merely schematic representations based on convenience and the ease of demonstrating the present disclosure, and are, therefore, not necessarily intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings. In the drawings and the following description below, it is to be understood that like numeric designations refer to components of like function.

The singular forms “a,” “an,” and “the” include plural referents unless the context clearly dictates otherwise.

As used in the specification, various devices and parts may be described as “comprising” other components. The terms “comprise(s),” “include(s),” “having,” “has,” “can,” “contain(s),” and variants thereof, as used herein, are intended to be open-ended transitional phrases, terms, or words that do not preclude the possibility of additional components.

All ranges disclosed herein are inclusive of the recited endpoint and independently combinable (for example, the range of “from 2 inches to 10 inches” is inclusive of the endpoints, 2 inches and 10 inches, and all the intermediate values).

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.”

It should be noted that many of the terms used herein are relative terms. For example, the terms “upper” and “lower” are relative to each other in location, i.e. an upper component is located at a higher elevation than a lower component, and should not be construed as requiring a particular orientation or location of the structure. As a further example, the terms “interior”, “exterior”, “inward”, and “outward” are relative to a center, and should not be construed as requiring a particular orientation or location of the structure.

The terms “top” and “bottom” are relative to an absolute reference, i.e. the surface of the earth. Put another way, a top location is always located at a higher elevation than a bottom location, toward the surface of the earth.

The terms “horizontal” and “vertical” are used to indicate direction relative to an absolute reference, i.e. ground level. However, these terms should not be construed to require structures to be absolutely parallel or absolutely perpendicular to each other.

The term “consisting essentially of” is used herein to limit the scope of a claim to the specified materials or steps and those that do not materially affect the basic and novel characteristics of the claimed subject matter. The term permits the inclusion of elements which do not materially affect the basic and novel characteristics of the apparatus under consideration. Accordingly, the expressions “consists essentially of” or “consisting essentially of” mean that the recited embodiment, feature, component, etc. must be present and that other embodiments, features, components, etc., may be present provided the presence thereof does not materially affect the performance, character or effect of the recited embodiment, feature, component, etc. For example, the inclusion of a vacuum drying step or other dry-down operation between the flotation dryer and the calendering operation to remove virtually all residual solvent would be considered to materially affect the basic and novel characteristics of the claimed subject matter.

Turning now to FIG. 5, there is shown a dual side coating, drying and calendering system 180 in accordance with certain embodiments. A substrate 20, such as a current collector, is shown wrapped around an unwind roller 22. In certain embodiments, the current collector is a metal foil suitable for use as an electrode for a battery, such as a lithium-ion battery. Typically the metal foil is copper for the anode and aluminum for the cathode. Those skilled in the art will appreciate that substrates other than current collectors may be used in the systems and methods disclosed herein, and the metal foil current collector substrate is merely an exemplary embodiment.

In certain embodiments, the substrate 20 is generally flat, and includes first and second elongated sides, with the first side being opposite the second side. In the embodiment shown in FIG. 5, the first side 20A is coated with a first coating head 24, and the second side 20B is coated with a second coating head 26. The coating operations may be carried out simultaneously or nearly simultaneously. A backing roll 25 may be used to support the substrate 20 during the coating application with the first coating head 24.

Suitable coatings applied to the first and second sides of the substrate 20 are not particularly limited. In embodiments where electrodes are being manufactured, the coatings are typically slurries that may include active material such as graphite (for the anode) and lithium (e.g., lithium oxide, for the cathode), and a binder. Active materials are typically in amounts greater than 90% by weight. Other additive materials such as conductive additives, binders, and thickening agents may be included. Binder content typically ranges from about 1% to about 10%, with lower amounts preferred. Suitable binders include TEFLON (PTFE), polyvinylidene fluoride, SBR latex, etc. The typical goal is to maximize the active material content while maintaining optimum cell performance and life. The coatings applied to each side of the substrate 20 can be the same or different, and can be applied in the same amounts or in different amounts. In embodiments where electrodes are being manufactured, typically the coatings applied to each side of the substrate 20 are the same and are applied in similar amounts, e.g., similar thicknesses.

Once the first and second sides of the substrate 20 have been coated, the substrate 20 is directed into dryer 30. In certain embodiments, the dryer 30 is a flotation dryer, since it desirable that the substrate 20 be contactlessly supported during drying to avoid damage to the coatings (and the substrate) that have been applied. One suitable arrangement for contactlessly supporting a substrate (or web) during drying includes a dryer housing containing horizontal upper and lower sets of nozzles or air bars between which the substrate travels. Hot air issuing from the air bars both dries and supports the web as it travels through the dryer 30. The dryer housing can be maintained at a slightly sub-atmospheric pressure by an exhaust blower or the like that draws off the moisture or other volatiles emanating from the substrate as a result of the drying of the water, coating, solvent, etc. thereon, for example. In certain embodiments the air bars may include flotation nozzle(s) which exhibit the Coanda effect such as the HI-FLOAT® air bar commercially available from Babcock & Wilcox Megtec, LLC, which exhibit high heat transfer and excellent flotation characteristics. In a typical dryer configuration with such Coanda flotation nozzles, upper and lower opposing nozzle arrays are provided, with each nozzle in the lower array (except for an end nozzle) positioned between two nozzles in the upper array; i.e., the upper and lower nozzles are staggered with respect to each other. Those skilled in the art will appreciate that other configurations of nozzles in the dryer 30 may be used, and that drying and/or flotation may be carried out or enhanced using other technologies including infrared, ultraviolet, electron beam, or any combination of the foregoing to effectively and efficiently achieve flotation and suitable drying or curing of the coating layers. For example, one or more of the nozzles may be a direct impingement nozzle, such as a direct impingement nozzle having a plurality of apertures, such as a hole-array bar, or a direct impingement nozzle having one or more slots, which provide a higher heat transfer coefficient for a given air volume and nozzle velocity than a flotation nozzle. As between the hole-array bar and the slot bar, the former provides a higher heat transfer coefficient for a given air volume at equal nozzle velocities.

The flotation dryer 30 may be comprised of a single zone having a set air temperature and set air jet velocity from the convection nozzles throughout the entire dryer length or, in preferred embodiments, comprised of two or more zones each having an independent set of air temperature and air velocity settings. Further, one or more zones may include the aforementioned technologies, including infrared, ultraviolet, electron beam, or any combination, to enhance the heating and drying of the coating layers at a given stage of the drying profile within the overall drying time in the dryer.

In certain embodiments, the drying or curing of the coating layers on the substrate 20 in dryer 30 is regulated so that a predetermined level of residual solvent from the coatings is retained when the substrate 20 exits the dryer 30. The residual solvent load affects the subsequent calendering force required to achieve the desired coating thicknesses or densities; greater residual solvent load reduces the required calendering force needed to achieve the required thicknesses and densities. In certain embodiments, it is desired to achieve porosities of from about 25% to about 40%, preferably about 30% to about 35%. The reduction in thickness from calendaring and resulting reduction in porosity typically ranges from 40 to about 35%. Electrode porosity as-coated typically ranges from around 50 to 60%, and is most often calculated by using the true densities of the individual components and their relative percentages in the electrode formulation. Porosity is difficult to measure or predict accurately because the electrode coatings dry and compact, or settle differently during the drying process based on the particle sizes and particle morphologies. In some embodiments, the drying is carried out so that a residual solvent level of from between about 0.05% to about 5% is retained on the substrate 20, with more preferable solvent level in the range from 0.2% to 2%. Uniform coating thicknesses are the objective, and in certain embodiments, thickness variances within about 1 micron are preferred, measured by methods known in the art. Since both sides of the substrate 20 pass through the dryer 30 only once, the properties of the applied coatings (e.g., residual solvent level, porosity, density, binder composition, etc.) are the same or substantially the same when the substrate exits the dryer 30. Those skilled in the art will recognize that a number of selections for solvents may be used in the preparation of battery electrode slurry to be mixed, coated and processed in embodiments disclosed herein, depending on, for example, required properties of the slurry. In addition to organic solvents (e.g., N-methyl-pyrrolidone (NMP)), water is also a commonly used solvent for certain slurry preparations (e.g., aqueous electrode slurries/coatings). Accordingly, residual solvent may refer to water or organic solvents as may be present as constituents of an electrode slurry to be processed, for example, and accordingly moisture remaining in the product after drying or further processing may be referred to as “residual moisture” or “residual solvent”. Typically the target residual solvent level after all drying operations are complete (e.g., the residual solvent level just prior to cell assembly) is 5% or less, and is often less than 200 ppm, and can be less than 100 ppm. In order to assist in calendering, however, in certain embodiments the first drying operation is carried out so as to achieve a residual solvent level higher than the final targeted residual solvent level. For example, in certain embodiments where NMP is the solvent, and the targeted final residual solvent level is less than 100 ppm, the first drying operation can be carried out so that a residual solvent level upon exiting the first dryer is about 1.5% in order to effectively reduce the amount of force required for calendering to the desired thickness/porosity. In some embodiments, a secondary drying operation can be carried out downstream to reduce the residual solvent level to the final targeted amount (e.g., less than 400 ppm, preferably less than 200 ppm and in some cases below 100 ppm).

In some embodiments, upon exiting the dryer 30, the substrate 20 is next subjected to an inline calendering operation. In certain embodiments, the inline calendering operation is carried out immediately after the substrate exits the dryer 30. In some embodiments, there is no off-line operation between dryer 30 and the calender, such as an off-line vacuum drying operation or dry-down period where typically the roll of substrate is removed from the process line, placed into a separate, off-line vacuum drying oven where it is vacuum dried, or placed in a controlled atmosphere storage chamber/room, and then placed back into the roll-to-roll process line, causing start-up and shut-down scrap generation. Accordingly, in certain embodiments, the initial drying and calendering are carried out without any intermediate off-line operations or apparatus. In some embodiments all of the apparatus and process steps to dual side coat the substrate 20 are carried out between the unwind and rewind rolls (or slitting/cell processing) without any off-line requirements.

As shown in FIG. 5, calendering may be carried out by passing the substrate 20 between the nip or gap formed between two opposing rollers 32A, 32B. Unlike conventional systems, no intermediate vacuum (or other) drying is necessary prior to the calendering operation. Since in some embodiments residual solvent or residual moisture is retained in the coating layers after drying in dryer 30, the residual solvent or residual moisture remaining may behave like a plasticizer and reduce the amount of compressive force required to densify the coated substrate, to the desired thickness. In certain embodiments, the roll diameters are designed to minimize roll-to-roll surface deflection from the calendering forces. In certain embodiments, the rolls 32A, 32B are made of steel, and are polished and/or chrome plated. In other embodiments, the rolls 32A, 32B may be deformable to improve a lamination process, and thus may be made of rubber or other elastomer. In some embodiments only one of the rolls is deformable. The nip between rolls may be controlled by constant force, but may also be controlled by fixed gap control, or by a combination of constant force and fixed gap control.

Calendering may be carried out at elevated temperatures. Suitable calendering temperatures range from about ambient temperature (e.g., 25° C.) to about 100° C. Higher temperatures can be used in the case of lamination, e.g., where a battery separator is laminated between cathode and anode foils. Calendering temperatures higher than ambient can be achieved by heating one or both of the calendering rolls, as is known in the art.

Suitable conveying speeds of the substrate are not particularly limited, and can be from about 0.1 meters/minute to about 50 meters/minute, and may be as high as about 200 meters/minute.

In certain embodiments, an inline secondary drying step may be carried out after calendering. As shown in FIG. 5, a secondary dryer 34 may be positioned downstream of the calendering operation to further dry the coatings on the substrate and reduce the residual solvent level to the final targeted value. In certain embodiments, inlet solvent/moisture levels of 5% or more may be contained in the coating entering the secondary dryer, with typical values in the range of 0.1 to 2%. The applied convection from heated air at temperatures in the range of 80 to 180° C. with conditioned drying atmosphere humidity levels dry the residual solvent/moisture levels in the coating to a target value, typically less than 400 ppm and preferably less than 200 ppm, and sometimes less than 100 ppm depending on the solvent/moisture residue requirement in cell production. Although a flotation dryer may be used as the secondary dryer, contactless support of the substrate is not necessary in this stage of the process since the coatings will no longer be damaged by contact with equipment such as rollers. In certain embodiments, the secondary dryer is configured to contain and convey a continuous web of substrate inside a drying enclosure, where the web is guided in a serpentine or “festoon” like path with the coating having been solidified or cured in a prior drying step. This arrangement provides a web path of substantial cumulative length to be contained within the volume of the secondary dryer while exposing both sides of the coated substrate to a drying atmosphere. Relatively long exposure times, such as drying times in the range of one half minute to 5 minutes may be accomplished in a smaller volume footprint as compared to other web path arrangements such as planar or arched roll support ovens. Exposure time may be calculated by dividing the cumulative path length of the festoon by the transport speed of the substrate to be dried. Total cumulative path lengths from 10 to 50 meters are practical with cumulative path lengths of 100 meters or more achievable with low inertia rollers or driven rollers.

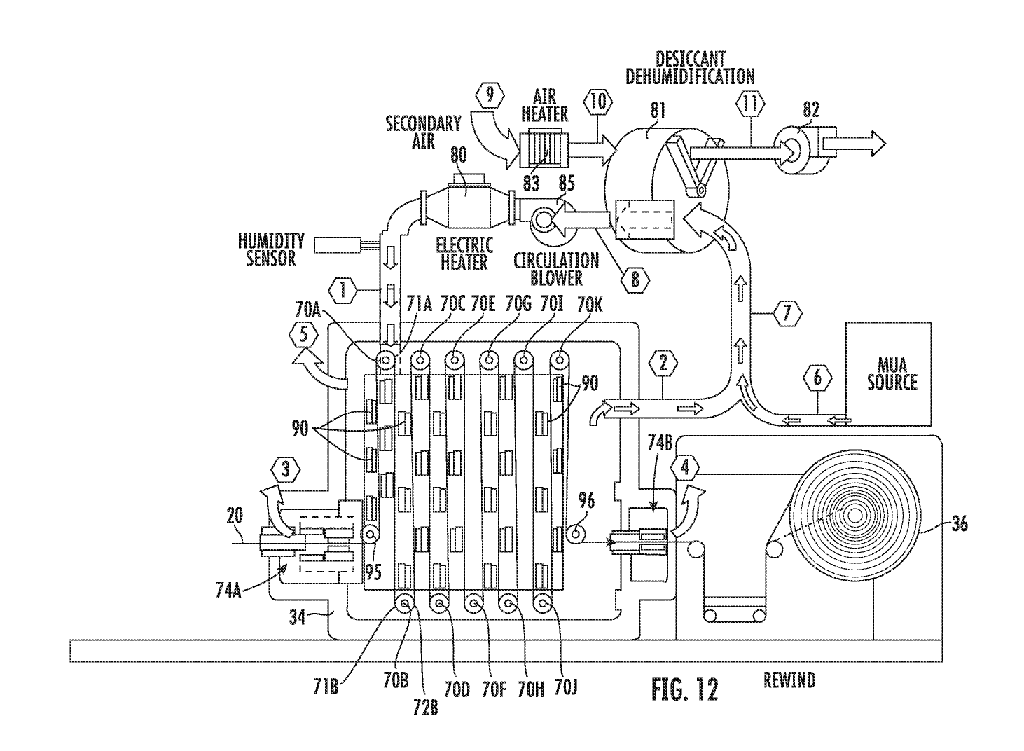

In certain embodiments, the web path may be defined by a plurality of rollers arranged as depicted in FIG. 12_in contact with the substrate or web 20, each roller altering the path of the web as it travels and is guided around each roller. As shown in FIG. 12, a supply of heated and conditioned drying air 1 from an electric heater 80 is introduced to the drying enclosure of secondary dryer 34 in order to create/control the drying atmosphere. Recirculated air 2 from the drying enclosure recirculates back to the air handling system. In some embodiments the air handling system may include desiccant dryer 81, which receives desiccant dryer secondary air 9 for desorption (typically ambient air), which is heated by heater 83 to produce heated desiccant dryer secondary air 10 for desorption. The resulting conditioned air 8 from the desiccant dryer 81 is fed to circulation blower 85 where it is then introduced to heater 80. Desiccant dryer secondary air exhaust 11 may be exhausted with fan 82. Make up air 6, which is typically ambient air that is filtered and preconditioned (by means of a suitable HVAC unit for removal of particulate contaminants such as dust, aerosols and the like and initial reduction of humidity to less than 60° F. due point) may be combined to form a mixture of recirculated and make up air 7, which is recirculated to the desiccant dryer 81. Suitable desiccant dryers include rotor-type dryers such as those commercially available from Munters. In some embodiments, the web entry and exit slots of the secondary dryer 34 may have air seals, and exfiltration of air from the dryer enclosure/air seal web entry and exit slots are respectively shown at 3 and 4.

In certain embodiments, the interior of the secondary dryer 34 includes a web entry guide roller 95 and a web exit guide roller 96 to respectively direct the web path into and out of the dryer. A plurality of rollers 70A to 70K are preferably arranged in pairs and supported in the dryer frame to a set distance between these pairs of rollers. The web is guided around a first roller 70A by wrapping and exiting at a tangent point 71A and follows a path defined by the tangent entry point 71B of a second roller 70B spaced from the first roller 70A by the support distance. After wrapping the second roller 70B, the web 20 exits the second roller 70B at an exit tangent point 72B and takes a path to the entry tangent entry point of a third roller 70C, preferably adjacent to the first roller 70A. This pattern is repeated in alternating fashion to define a cumulative web path around the rollers made up by the plurality of strands defined by the pairs of rollers. Thus, top rollers 70A and 70C are neighboring or adjacent (next to each other) as are rollers 70C and 70E, 70E and 70G, and 70G and 70I. Similarly, bottom rollers 70B and 70D are neighboring or adjacent (next to each other), as are rollers 70D and 70F, 70F and 70H and 70H and 70J. The number of rollers is not particularly limited. The arrangement may be vertical as shown or horizontal or any web strand path angle conducive to the space available for the drying enclosure. Wrap angles around rollers may be 180° as shown, or from 90° to slightly over 180° such as to fit nozzles and be most compact. The rollers may be supported on a frame or the like (not shown). The web 20 exits the dryer 34 and may be wound on rewind roll 36.

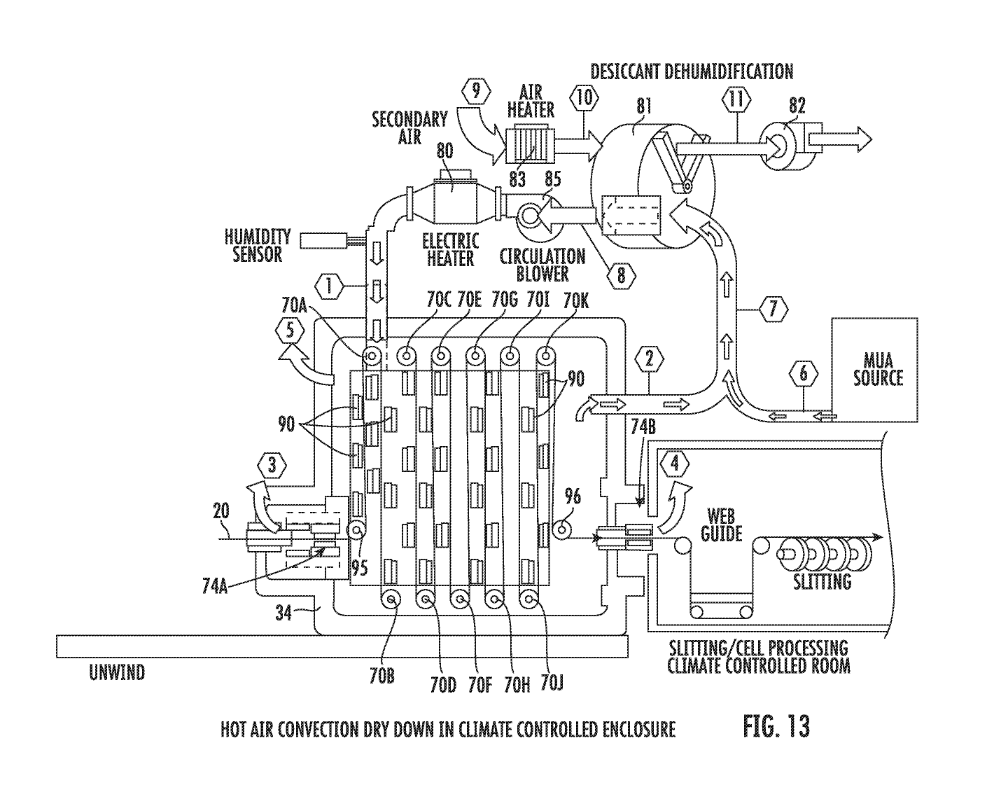

FIG. 13 illustrates a similar embodiment, except that it is a roll-to-direct process arrangement rather than the roll-to-roll arrangement of FIG. 12. Thus the rewind operation is eliminated, and the substrate is directed to post processing (e.g., a slitting operation) immediately after it exits the secondary dryer 34.

The drying atmosphere in the secondary dryer is preferably heated to an elevated temperature up to 180° C., more preferably in the range of 80 to 140° C. such as by an electric, steam or thermal fluid coil in communication with the secondary drying enclosure and further in communication with a fan or the like providing the means of circulating drying air though the heating coil and within the secondary dryer enclosure. In some embodiments, the circulating air is brought into contact with the web path strands between supporting path rollers after being heated and conditioned by ducting the circulating air into nozzles or blow boxes 90 mounted near and between the web path strands. In certain embodiments the air may be directed into contact with the web by circulating the drying atmosphere in a co-current path (relative to the direction of web travel) along the web path strands or alternatively in a countercurrent path (relative to the direction of web travel). In a preferred embodiment, the drying air is directed into contact with the web by air jets emanating from the nozzles or blow boxes 90 providing convection heat transfer to the web. The air jets may be discharged from slots or arrays or holes or other aperture shapes configured to provide heat transfer coefficients to the web surface. In some embodiments, the air jets are configured to provide heat transfer coefficients to the web surface in the range of 10 to 50 watts per square meter per degree C. In some embodiments the web may be optionally heated by infrared emitters (not shown) in addition to or instead of convection air from nozzles or blow boxes 90. In certain embodiments the festoon path rollers may be heated in order to conduct heat to the web as it contacts the rollers. In certain embodiments the rollers may be heated by a heated thermal fluid circulated through the rollers via rotary unions in fluid communication via roller journals to allow flow of the thermal fluid through interior flow channels in the rollers. In some embodiments the rollers may be heated internally by electric resistance elements (e.g., heater rods) supported within the rollers and connected by electrical conductors through journals to a variable power supply such as a silicon controlled rectifier device to control the temperature of the rollers and the resultant heat conducted to the web.

The drying atmosphere in the secondary dryer enclosure may be further conditioned to a low humidity to promote moisture removal from the drying atmosphere. For example, a desiccant dryer unit 81 or other suitable air dryer may be used in communication with the aforementioned circulating air heater and fan to reduce the humidity of the drying air, such as reducing the humidity below 1000 ppm water by volume, preferably in the range of 50 to 200 ppm. Makeup air may be similarly conditioned to a low humidity before being admitted into the secondary dryer enclosure.

The drying atmosphere in the secondary dryer enclosure is isolated from the room by means of narrow web entry and exit slots and preferably may be further isolated from room air infiltration by air seals 74A, 74B which prevent room air from entering the secondary dryer enclosure by injecting dry seal air creating a slight overpressure compared to room pressure in the range of 5 to 30 Pascals. A portion of the circulating air may be expelled through the web slots as exhaust. Optionally exhaust may be expelled from the secondary dryer enclosure through an exhaust port to relieve the buildup of organic solvents if present in the coated material being dried.

After the secondary drying step, additional process steps may be carried out, or the substrate may be conveyed with suitable web handling apparatus and ultimately rewound on a roller 36, for example.

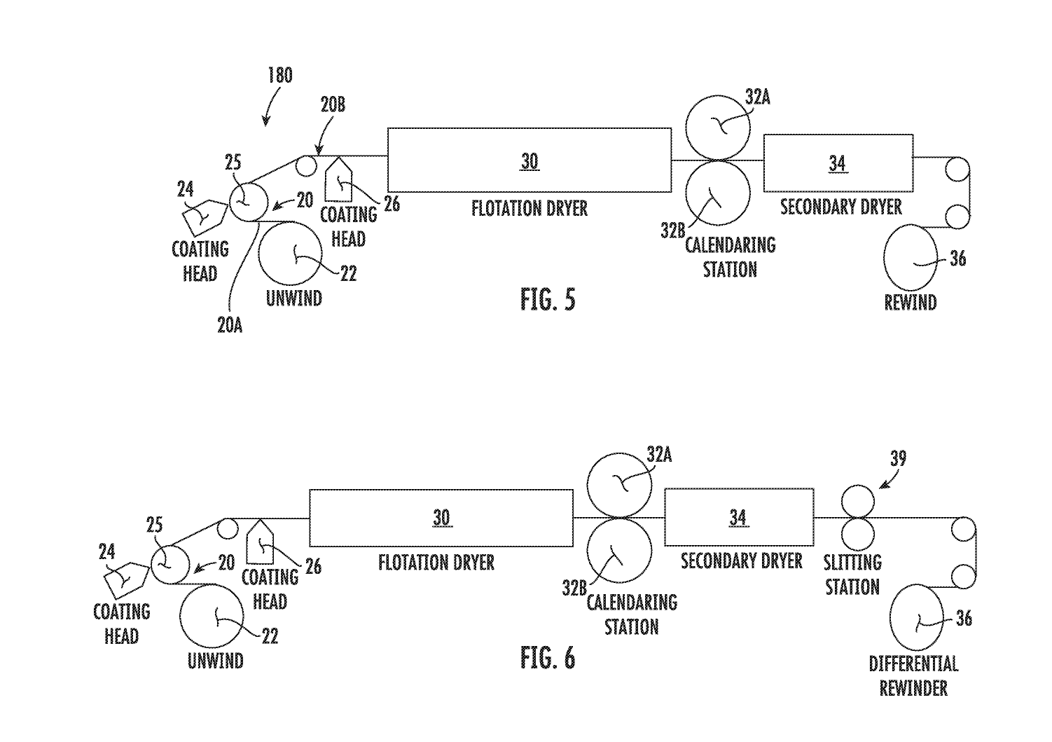

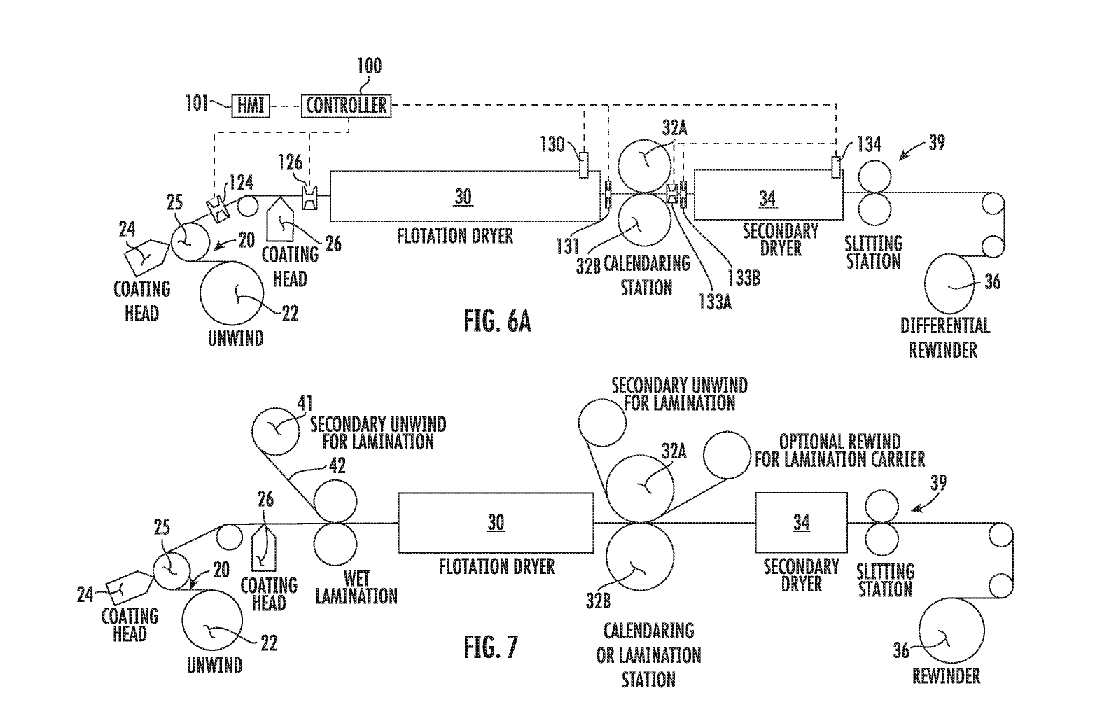

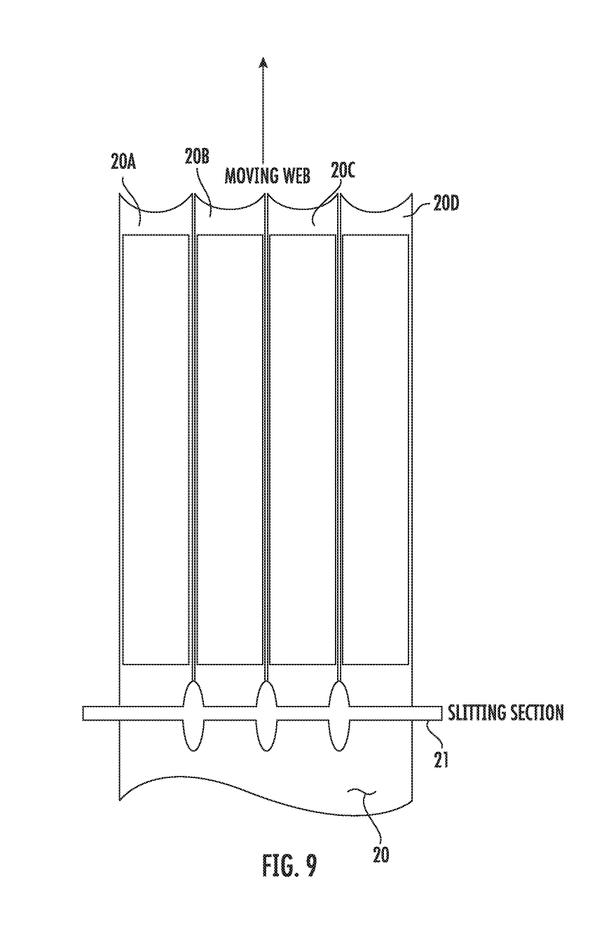

FIG. 6 illustrates an embodiment where a slitting station 39 is provided downstream of the calendering operation and secondary dryer, if present. Alternatively, the slitting station 39 could be positioned downstream of the calendering operation but upstream of a secondary dryer. In some embodiments, slitting of the substrate 20 (an example of which is shown in FIG. 9) may be carried out to create regions for current collecting tab attachment, for example. In the embodiment shown in FIG. 9, the coating 19 is shown in black, and the substrate 20 is slit into four sections 20A, 20B, 20C and 20D. Suitable slitters 21 include shear slitters with knives. In some embodiments, a differential rewinder may be used to rewind multiple slit rolls of material.

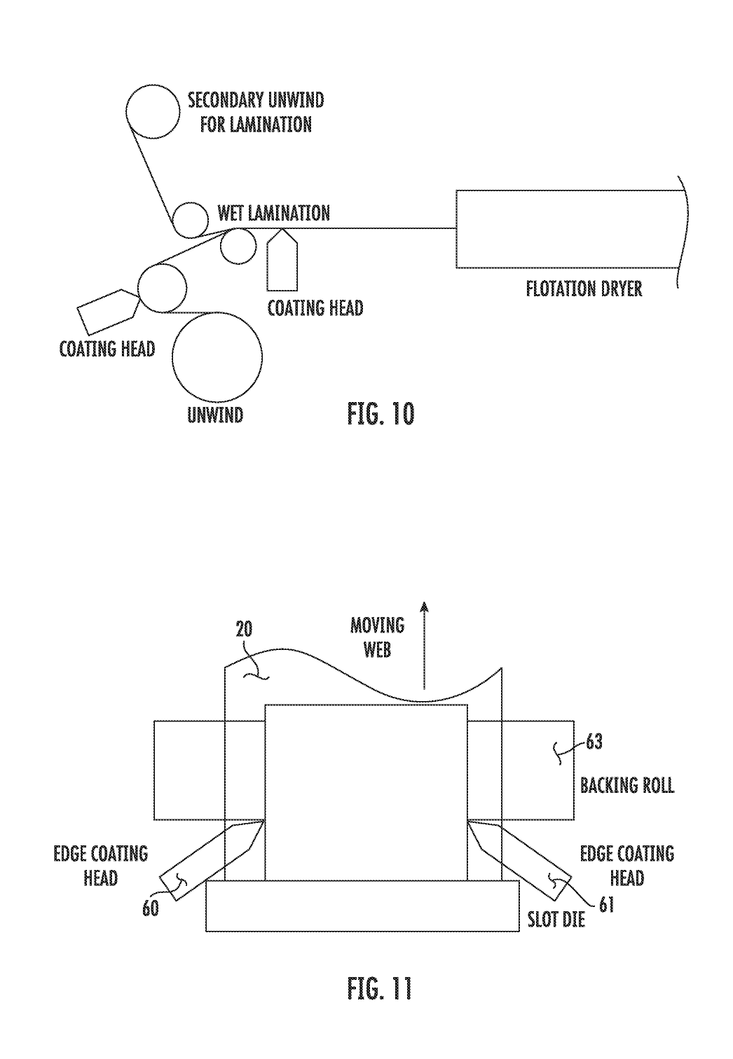

FIG. 7 illustrates an embodiment where a lamination step is carried out prior to the dual coated substrate entering the flotation dryer 32. An unwind roll 41 is provided for unwinding the material 42 being laminated onto the substrate 20, such as a polymer electrolyte coated on a carrier web such as skived TEFLON. Immediately after the coating step, an expanded PTFE (ePTFE) web may be wet laminated into the wet polymer electrolyte before entering the dryer for drying. The lamination can be a wet lamination process such as that illustrated in FIG. 10. An optional (secondary) further lamination step can be carried out after the substrate exits the dryer, such as during the calendering step. In certain embodiments, a carrier liner can be laminated to one or both sides of the coated substrate, using either a wet or dry lamination process. The lamination could also be a coating process that laminates directly onto the substrate or the carrier, or an indirect coating method that is transferred onto the coated web or lamination carrier. In the case of wet lamination, a nip cannot be used because the wet coating layer can be disturbed. Instead, in some embodiments the film to be laminated is fed from an unwind that is preferably driven through an idler placed near the wet coating layer. The lamination point on the substrate occurs at another idler seen in FIG. 10 above where the wet coating on the substrate “wraps” over an idler. This “wrapping” point creates the lamination point for the process.

In certain embodiments, secondary coating applications can be included, such as for edge coating of the substrate at the primary coating heads, or anywhere else in the process flow. For example, secondary coating operations can be carried out at existing coating stations, at the first wet lamination station, or before or after the calendering operation. For example, the edge coating process may be an insulating coating, such as a mixture of PVDF as a binder in NMP, with fumed silica, or some other ceramic type of material. FIG. 11 shows a typical setup for edge coating. These coating heads 60, 61 are more like syringes, or a slot die with a more rounded opening, but not exclusively the case. These edge coating heads 60, 61 can be placed against a backing roll 63, or near a freespan die for the tensioned-web side coating. In other embodiments, a multilayer slot die could be used, which feeds multiple coatings through multiple slots in the same slot die body. Multilayer dies are well known in the extrusion art and photographic film industry.

In some embodiments, a series of combined dual side coating and calendering operations can be combined to create multilayer, variable density electrodes, or electrodes with varying coating compositions. These multilayer electrodes could be coated in multiple layers at the preferred coating location, or a series of sequential or tandem simultaneous dual side coating machines could be connected in series to carry out to coat, dry and calender multilayer or variable density or electrodes with varying compositions.

In some embodiments, a controller may be provided, the controller having a processing unit and a storage element. The processing unit may be a general purpose computing device such as a microprocessor. Alternatively, it may be a specialized processing device, such as a programmable logic controller (PLC). The storage element may utilize any memory technology, such as RAM, DRAM, ROM, Flash ROM, EEROM, NVRAM, magnetic media, or any other medium suitable to hold computer readable data and instructions. The controller unit may be in electrical communication (e.g., wired, wirelessly) with one or more of the operating units in the system, including one or more of the coating heads, the dryer, the calender, the slitter, web conveying equipment, sensors, etc. The controller also may be associated with a human machine interface or HMI that displays or otherwise indicates to an operator one or more of the parameters involved in operating the system and/or carrying out the methods described herein. The storage element may contain instructions, which when executed by the processing unit, enable the system to perform the functions described herein. In some embodiments, more than one controller can be used. In certain embodiments, all of the unit operations enabling the dual side coating operation are controlled by a single PLC system.

In certain embodiments, one or more sensors can be used to identify when the thickness areas of coating exceed a predetermined level. The one or more sensors can send a signal to the PLC, and in response to that signal, the calendering operation can be modified (such as by increasing the size of the nip between calender rolls to help prevent damage to the calender rolls). In certain embodiments, the sensors may be laser thickness gauges, ultrasonic coat weight gauges, beta gauges, or simple mechanical drop gauges. In some embodiments, sensors are upstream of the calender to sense heavy or over-thickness, and prevent damage to the calender rolls. In certain embodiments, sensors are downstream of the calender to sense thickness and provide feedback control in order to control the calender gap or nip. In some embodiments, both upstream and downstream sensors may be used.

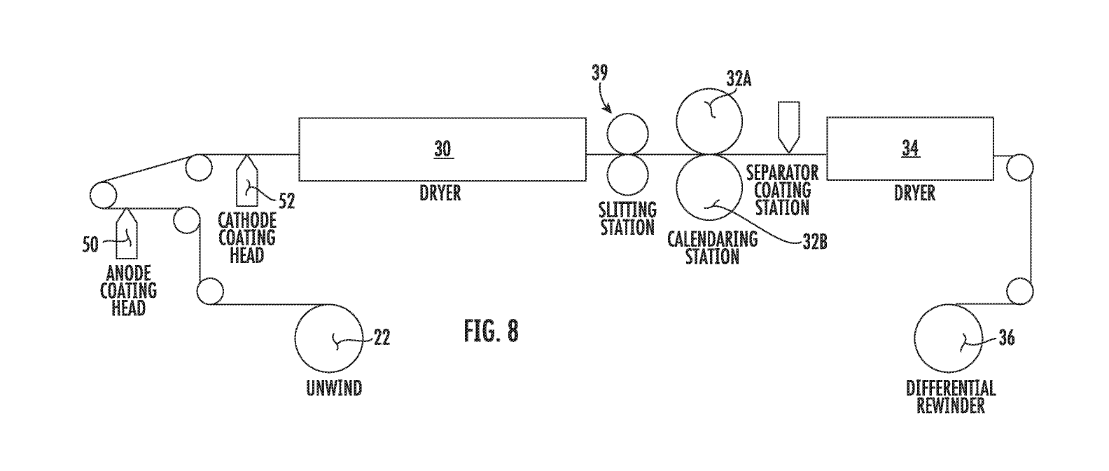

FIG. 8 illustrates an embodiment where the anode and cathode electrodes can be coated simultaneously. For example, the substrate can be a composite of insulating material such as polyamide, TEFLON, polyethylene, etc. that is metalized or coated with conductive material on each side; copper for the anode and aluminum for the cathode. As this substrate passes through the system, the anode active material is coated onto the copper by anode coating head 50, and the cathode active material is coated onto the aluminum by copper coating head 52. The dual side coated substrate is then dried and calendered as described previously, and may be subjected to additional unit operations including slitting, lamination, etc. The result is a roll-to-roll wound battery cell in a single integrated process.

### EXAMPLE

The following example illustrates how the controller, control elements and process equipment may function as an inline process in accordance with the embodiment of FIG. 6. It is to be understood this example serves only as an illustration of control functionality for one set of process conditions and that many other conditions are possible as needed to meet dried product requirements in the operation of the inline processes presently disclosed.

An aluminum foil substrate 600 millimeters wide and 15 microns in thickness is to be coated both sides with a water-based cathode slurry and dried to produce a dry and calendered coating thickness of 50 microns per side at a density of 1.5 grams per cubic centimeter with less than 200 ppm residual moisture. The line speed (transport speed of the web) is to be 20 meters per minute. The aluminum substrate 20 is fed as a continuous web from a roll of said substrate mechanically held and unwound in unwind 22 and conveyed under controlled tension to follow a web path backing roller 25. Coating head 24 is fed wet coating slurry having 33% solids from a suitable fluid handling pumping system (not shown) and is discharged from a slot die aperture at a volumetric flow rate initially set in the control unit to coat the first side of the substrate with wet coating to an initial target wet thickness of 175 microns (via setting the pump speed and coating head 24 slot die gap and gap distance from slot die discharge to the substrate). Following slurry application at the first coating head 24, the applied mass of coating is (optionally) measured with an ultrasonic coat weight gauge 124 (or alternatively a beta gauge) positioned to measure the amount of coating on the moving web now coated on one side before reaching the position of the second coating head 26. Based on said coat weight measurement and the specific gravity of the solids in the wet slurry as specified in the slurry formulation, a mass-balance determination of the equivalent dry coating mass per unit area and calendered thickness can be made in the controller unit 100 and compared to the coat weight density and thickness specifications previously stated. These specifications or production targets are entered into the controller unit 100 memory through a human-machine interface (HMI) 101. These specifications are set up as recipes for easy retrieval and modification for the various product type production targets stored within. If the calculated coat weight differs from the target value, a new target wet thickness is calculated automatically in the control unit (or alternatively by manual means) and the volumetric flow rate of wet slurry supplied to the first coating head 24 is increased in the case of the measured value being less than the target, or decreased in the case where the measured thickness value exceeds the target. Accordingly the pump speed is increased or decreased by the control function output to the pump drive in the control unit.

Following application (and optional measurement) of the coating to the first side in the first coater, the web now traverses over a second coating head 26 which is similarly fed wet coating slurry having 33% solids from a suitable fluid handling pumping system (not shown) and is discharged from a slot die aperture at a volumetric flow rate initially set in the control unit to coat the first side of the substrate with wet coating to an initial target wet thickness of 175 microns (via setting the pump speed and coating head 26 slot die gap and gap distance from slot die discharge to the substrate) to form the second side coating. Following application of the second coating the total applied mass of both first and second coatings is (optionally) measured with an ultrasonic coat weight gauge 126 (or alternatively a beta gauge) positioned to measure the amount of coating on the moving web now coated on both sides before entering the dryer 30. Based on subtracting the previous first side coat weight measurement following the first coating head 24 from said value of the total coat weight measurement and the specific gravity of the solids in the wet slurry as specified in the slurry formulation a determination of the equivalent dry coating mass per unit area and thickness on said second side can be made in the controller unit and compared to the thickness specification previously stated as 50 microns. If the calculated second side coat weight and thickness differs from the target value, a new target wet thickness is calculated automatically in the control unit (or alternatively by manual means) and the volumetric flow rate of wet slurry supplied to the second coating head 26 is increased in the case of the measured value being less than the target, or decreased in the case where the measured thickness value exceeds the target.

Immediately following the aforementioned applications of wet coating on both sides of the substrate, the coated web is subsequently dried (both sides simultaneously) in, for example, a 3-zone flotation dryer 30 with a total drying length of 24 meters to remove the moisture from the wet coating. Drying air temperature and flow velocities supplied to the flotation nozzles in the flotation dryer 30 are selected to sufficiently dry both the top (first) and second (bottom) coatings uniformly to a target residual moisture level of 2.5% known to maintain plasticity which is helpful in subsequent calendering operations. The temperature of the coated web is measured by means of non-contact infrared temperature sensors (not shown) sighted at the moving web through ports in the dryer enclosure or mounted internally with suitable cooling of the infrared sensors. The web temperature is measured at the exit of the dryer by non-contact IR sensor 130 and in preferred embodiments similarly at the end of each dryer zone, each of said zones having specific air velocity and air temperature settings in order to reach a target web exit temperatures corresponding to the target exit moisture of 2.5%. Said corresponding web temperature and velocity settings are predetermined in the control unit by algorithms developed for each type of battery coating from structured experiments (such a “designs of experiments” known as DOE's), regression studies, drying engineering models or other suitable techniques alone or in combination as are known to those skilled in the art of drying operations. The predetermined settings are typically stored as recipes in memory in HMI 101 and loaded in the controller unit 100 (PLC) memory during make ready procedures for the battery collector product to me produced. In the present example the flotation air jet velocities are set by the control unit are in the range of 30 to 35 meters per second in order to deliver heat transfer coefficients in the range of 50 to 100 watts per square meter per Celsius degree, and the web exit temperature control in Zone 3 measured with sensor 130 is set at 65° C. as determined in said algorithm to reach the exit target of 2.5% moisture. Said zone air temperatures are measured and regulated to set points of 110, 115 and 120° C. in Zones 1, 2 and 3 respectively by closed-loop control systems included for each zone. Nozzle air jet velocities are preferably measured and regulated to set point by closed-loop control systems included for each zone.

Following the dryer, the coated web is cooled by contact with ambient room air and then enters the inline calender operation at about 30° C. In calendering operation, the nip distance between calender rollers 32A and 32B is set to a minimum gap of 100 microns set by fixed mechanical stops with an applied nip compression force of 200 N/mm to increase the coating density and reduce the thickness to the target value of 50 microns per side. Following passage through the calender nip the applied mass of coating is preferably measured with an ultrasonic coat weight gauge 133A (or alternatively a beta gauge) positioned to measure the amount of coating on the moving web now coated on both sides, dried and calendered. Preferably the thickness of the coating layers alone is determined at this same location with an optical laser thickness gauge 133B measuring total thickness and subtracting the known substrate thickness of 15 microns. Based on the measured coating layer thickness coat weight measurement and the specific gravity of the solids and residual moisture, a mass-balance determination of the equivalent dry coating density can be made in the controller unit and compared to the coat weight specification previously stated as 50 microns per side and the target density of 1.5 grams per cubic centimeter.

Prior to undergoing the inline calendering process in the nip rollers 32A and 32B, the coating layer thickness on each side of the substrate is inspected for excess thickness profile which could otherwise damage the calender rollers. The inspection is carried out optically with a high speed laser scanner device 131 (or a high speed camera or other suitable surface profile inspection device) capable of sensing a lump or local defect representing excess thickness of 30 percent or more thickness above specification before it enters the nip and triggering a response to avoid damage to the nip. The triggered response includes sending a signal to controller unit 100 relieving nip pressure and signaling high speed actuator 132 which opens the nip to 1 millimeter or more for safe passage of the detected thickness defect.

From the foregoing measurements and calculated values for coat weight per unit area, thickness and coating density, the controller unit 100 is programed to make process adjustments accordingly. If the coating weight is correct but the thickness differs from the specified thickness of 75 microns per side, adjustments to the calender nip gap and pressure settings are made while the amount of coating applied at the coating heads is kept constant. For this case, if the coating thickness is greater than the total of 50 microns per side plus substrate thickness, the calender nip gap and or pressure are increased to approach the specified thickness. Conversely, if the coating thickness is less than the total of 50 microns per side plus substrate thickness while the total coat weight is within specification, the calender nip gap and or pressure are reduced to approach the specified thickness. These adjustments are preferably made by the controller unit 100 as supervisory function acting on the set points of the calender operation while local sensors monitoring gap position and nip pressure and their associated control modules (not shown) monitor and regulate the high speed mechanical functions necessary in manipulating nip pressure and nip gap settings in the calender roll set. In the alternative case the total thickness of the coating layers meets the specification while the coating weight per unit area (and hence coating density) differ from specification, the amount of applied coating from the coating heads is adjusted to approach the correct value. In this case the calculation of the applied wet thickness target at each respective coating head is recalculated in the control unit and the flow of wet coating flow (pump speed) to each respective coating head is adjusted accordingly. These adjustments to coating head operation are preferably made by the controller unit 100 as supervisory function acting on the set points of the local coating head fluid delivery operation.

To further emphasize the intent of the foregoing description of the control function as an inline control system, the coat weight of the first applied coating is measured while wet, followed by application of the second wet coating. The total weight per unit area of both wet coatings is preferably measured before drying in order to achieve correct balance of the applied coat weights on each respective side of the web (top and bottom). Following drying and calendering, the total thickness and total coat weight per unit area are measured allowing direct calculation of coating density. Immediate inline adjustments of wet coating operation at the coating heads on each side of the web and adjustment to thickness adjustment in the calendering operation are made in response to one or more of these measurements.

Continuing the example, following the calendering step and weight and thickness measurements of the coating, the web is preferably guided into an inline secondary drying operation to reduce the residual moisture from 2.5% to the target value, e.g., less than 200 ppm. The target exit web temperature and drying atmosphere temperature in the secondary dryer is predetermined to be 175° C. in the control unit by algorithms developed for each type of battery coating from structured experiments (such a “designs of experiments” known as DOE's), regression studies, drying engineering models or other suitable techniques alone or in combination as are known to those skilled in the art of drying operations. In the present example the air is heated by an electric coil to a set point temperature of 180° C. and regulated by a closed loop control system regulating the heat output from the electric coil. The temperature of the web exiting the secondary dryer is measured at one or more locations across the width of the web by means of a non-contact infrared temperature sensor 134 (or array of infrared temperature sensors or alternatively a line-scanner temperature sensor) sighted at the moving web through ports in the dryer enclosure or mounted internally with suitable cooling of the infrared sensors. Adjustments to the air set point temperature are made based on the deviation of the measured value of the web exit temperature and the target exit web temperature adjusting the air set point temperature as a cascade control function.

Finally, following the secondary dryer 34, the web is conveyed to an inline slitting operation wherein the calendered and fully dried coated web is slit longitudinally into four strands and wound into individual rolls marked and cataloged to be consumed as cathode material in lithium ion cell manufacture.

In the summation of the foregoing inline process steps it is to be appreciated that the entire process history of each cataloged slit roll of collector material is captured in the storage element of the control system controller unit 100 and can be further processed and transferred by data transfer either wired or wirelessly to a subsequent process (typically battery cell assembly) for functional production control and as process records for quality control and verification, and recordkeeping. For example, exact process conditions from recorded measurements taken at every inline processing step are synchronized over the length of coated product produced and used as input process values representing real time measured values for the coated and processed collector material as the web is unwound and fed into the cell manufacturing step. For example, the stored process data includes coating density, thickness and residual solvent values mapped by position in a given roll of material. This data may be used in a feed-forward control fashion to divert off-spec material from said roll feeding the cell assembly step to scrap or to a recovery step where the off-spec material may be retained being suitable for purposes of another cell having different thickness or density specifications.

What is claimed is:

1. A system for coating first and second sides of a substrate in a single pass, comprising:
a. A first coater for applying a first coating layer to the first side of said substrate;
b. A second coater for applying a second coating layer to the second side of said substrate;
c. A dryer downstream of said second coater for drying the first and second coating layers such that the first and second coating layers retain a predetermined level of residual moisture;
d. A calender positioned downstream of said dryer for calendering the first and second coating layers.

2. The system of claim 1, wherein said calender is immediately downstream of said dryer.

3. The system of claim 1, wherein said substrate is a metal foil.

4. The system of claim 1, wherein said first side is opposite said second side.

5. The system of claim 1, wherein said first coating layer comprises an active electrode material.

6. The system of claim 5, wherein said active electrode material comprises lithium.

7. The system of claim 1, wherein the predetermined level of residual moisture is effective for achieving a target coating thickness on said substrate with a calendering force applied by said calender that is less than the force required at a level of residual moisture higher than said predetermined level.

8. The system of claim 1, wherein said substrate proceeds from said dryer to said calender without being subjected to an offline dry down period.

9. The system of claim 1, wherein said substrate proceeds from said dryer to said calender without being subjected to offline vacuum drying.

10. The system of claim 1, wherein said dryer is a flotation dryer.

11. The system of claim 1, further comprising a secondary dryer downstream of said calender.

12. The system of claim 10, wherein said secondary dryer is a festoon dryer.

13. A method of coating first and second sides of a substrate in a single pass, comprising:
a. Applying with a first coater a first coating layer to the first side of said substrate;
b. Applying with a second coater a second coating layer to the second side of said substrate;
c. Non-contactlessly drying said first and second coating layers in a flotation dryer positioned downstream of said first and second coaters such that the first and second coating layers retain a predetermined level of a residual moisture when exiting said dryer;
d. Calendering said coated substrate downstream of said drying.

14. The method of claim 13, wherein said calender is immediately downstream of said dryer.

15. The method of claim 13, wherein said substrate is a metal foil.

16. The method of claim 13, wherein said first side is opposite said second side.

17. The method of claim 13, wherein said first coating layer comprises an active electrode material.

18. The method of claim 17, wherein said active electrode material comprises lithium.

19. The method of claim 13, wherein the predetermined level of residual moisture is effective for achieving a target coating thickness on said substrate with a calendering force that is less than the force required at a level of residual moisture higher than said predetermined level.

20. The method of claim 13, wherein said substrate is not subjected to an offline dry down period between the steps of non-contactlessly drying said first and second coating layers and calendering.

21. The method of claim 13, wherein said substrate is not subjected to offline vacuum drying between the steps of non-contactlessly drying said first and second coating layers and calendering.

22. The method of claim 13, further comprising, after calendering, subjecting said substrate to secondary drying.

23. The method of claim 22, wherein said secondary drying is carried out in a festoon dryer.
